(19) United States
(12) Patent Application Publication
(10) Pub. No.: US 2016/0174529 A1
(43) Pub. Date: Jun. 23, 2016

(54) Pole Covering Device

(71) Applicant: Tony Wright, Thomson, GA (US)

(72) Inventor: Tony Wright, Thomson, GA (US)

(21) Appl. No.: 14/924,307

(22) Filed: Oct. 27, 2015

Related U.S. Application Data
(60) Provisional application No. 62/068,915, filed on Oct. 27, 2014.

(51) Int. Cl. A01K 39/01

(52) U.S. Cl. CPC A01K 39/0113

(57) ABSTRACT

A pole cover for a pole is provided. The pole cover may cover a bird feeder pole and be adapted to prevent squirrels and other unwanted animals from accessing the bird feeder. The cover comprises a sheet formed into an axially elongated hollow cylinder that may be mounted to an existing pole via one or more attachment mechanisms. The cover may further comprise an outer surface having a layer of non-stick coating.

### CROSS REFERENCE TO RELATED APPLICATIONS

This application claims the benefit of U.S. Provisional Application No. 60/068,915 filed on Oct. 27, 2014. The above identified patent application is herein incorporated by reference in its entirety to provide continuity of disclosure.

### FIELD OF THE INVENTION

The present invention generally relates to bird feeder devices. More particularly, the present invention relates to devices for preventing squirrels and other unwanted animals from climbing a pole in order to access a bird feeder thereon.

### BACKGROUND OF THE INVENTION

People around the world enjoy the presence of birds on their property. For many, birds are visually appealing and produce pleasant sounds. A common way of attracting birds is to place a bird feeder somewhere on the property. Bird feeders provide food for passing birds and tend to attract more birds to their location. However, bird feeders often attract other unwanted animals, such as squirrels, chipmunks, and other small ground-dwelling animals.

Typical bird feeders consist of a feed reservoir attached to the top of a pole which has been placed in the ground. Many animals such as squirrels can easily scale the pole and access the feed reservoir meant for birds. The presence of squirrels may deter birds from using the feeder. Further, the feed supply may be quickly depleted by unwanted animals. Squirrels tend to gather food and store it for future consumption, leaving even less food in the feeder for birds. As such, there is a need in the prior art for a means for preventing squirrels and other unwanted animals from climbing poles in order to access to an attached bird feeder.

Some prior art devices consist of a guard attachment that is secured underneath the feed reservoir of a bird feeder in order to block access from below. However, squirrels and similar animals are adept climbers and may easily circumvent the guard and access the bird food. Other prior art devices consist of spring-loaded attachments that shake and rattle under the weight of a squirrel, which causes the squirrel to either fall from the device or to be frightened away. These devices have the effect of frightening away the birds meant to be attracted to the feeder. The devices fail to provide a cover for positioning around a pole that is configured to deter squirrels and other unwanted animals from climbing the pole on which a bird feeder rests, while still allowing birds to be attracted thereto.

### SUMMARY OF THE INVENTION

In view of the foregoing disadvantages inherent in the known types of squirrel deterring devices now present in the prior art, the present invention provides a cover for a bird feeder pole wherein the same can be utilized for providing convenience for the user when preventing squirrels and other animals from climbing a pole.

It is therefore an object of the present invention to provide an improved pole cover that has none of the disadvantages of the prior art.

Another object of the present invention is to provide a pole cover for a pole comprising an axially elongated unitary sheet having two opposing vertical edges, wherein the two opposing vertical edges are attached to one another such that the unitary sheet forms a hollow cylinder adapted to accept a pole therethrough.

A further object of the present invention is to provide a pole cover further comprising one or more spikes disposed along the edge of a lower end of the cover, wherein each spike is oriented in the axial direction of the cover.

Yet another object of the present invention is to provide a pole cover having one or more mounting apertures disposed along the length of the cover.

Still a further object of the present invention is to provide a bird feeder assembly comprising a pole, a pole cover disposed around the pole, and a feed reservoir, wherein said feed reservoir is mounted to the top of the pole.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of a bird feeder mounted to the top of a pole.

FIG. 1B shows a perspective view of the pole cover secured to a pole wherein a bird feeder is mounted to the top of the pole.

FIG. 2 shows a cross-sectional view of the pole cover secured to a pole.

FIG. 3 shows a perspective view of the bottom edge of the pole cover.

### DETAILED DESCRIPTION OF THE INVENTION

Reference is made herein to the attached drawings. Like reference numerals are used throughout the drawings to depict like or similar elements of the bird feeder pole cover. For the purposes of presenting a brief and clear description of the present invention, the preferred embodiment will be discussed as used for preventing squirrels and other unwanted animals from climbing a pole. The figures are intended for representative purposes only and should not be considered to be limiting in any respect.

The term “squirrel” as used herein is intended to be broad enough to apply to any rodent, varmint, or wild animal, such as a cat, and especially squirrels, which are inclined to climb the pole supporting a bird feeder. The squirrel is the most common example of such an animal.

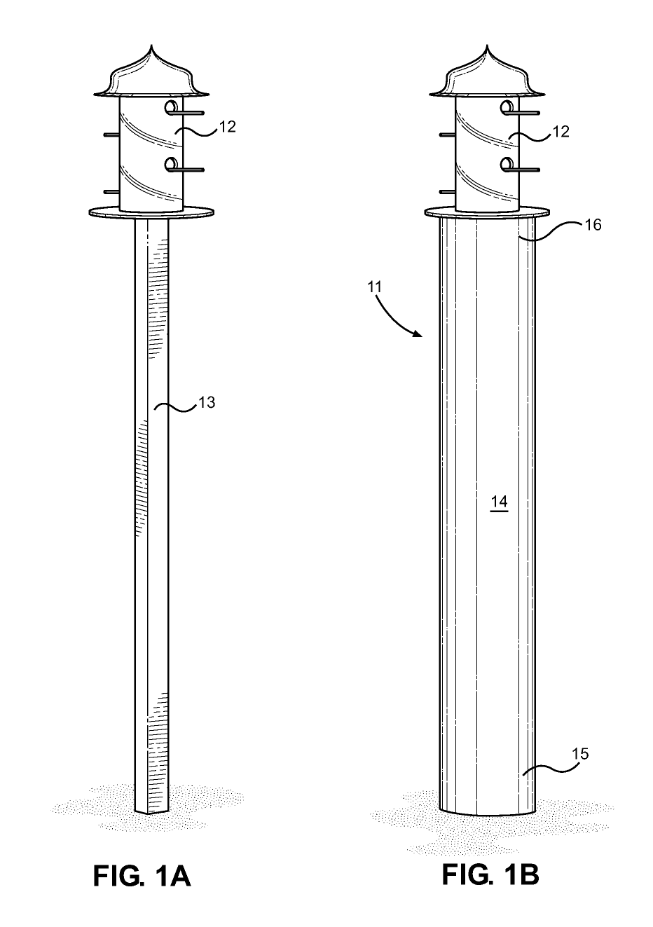

Referring now to FIGS. 1A and 1B, there is shown a perspective view of a bird feeder mounted to the top of a pole and a perspective view of the pole cover secured to a pole wherein a bird feeder is mounted to the top of the pole, respectively. The pole cover 11 may be used with any type of pole. The pole cover 11 is a unitary construction comprising an axially extending sheet of material formed into an elongated hollow cylinder. The pole cover 11 has an upper opening 16 and a lower opening 15 for accepting a pole therethrough. Preferably, the pole cover 11 is mounted such that a feed reservoir 12 is flush with the upper opening 16 of the pole cover 11. This prevents squirrels from utilizing a gap between the pole cover 11 and the feed reservoir 12 to reach the feed reservoir 12.

In some embodiments, the cover 11 comprises a non-stick outer coating layer 14. The non-stick outer coating layer 14 prevents squirrels from gaining traction when attempting to climb the pole cover 11. The cover 11 may be formed from any durable material such as PVC, aluminum, stainless steel, or any material to which a non-stick layer may be applied.

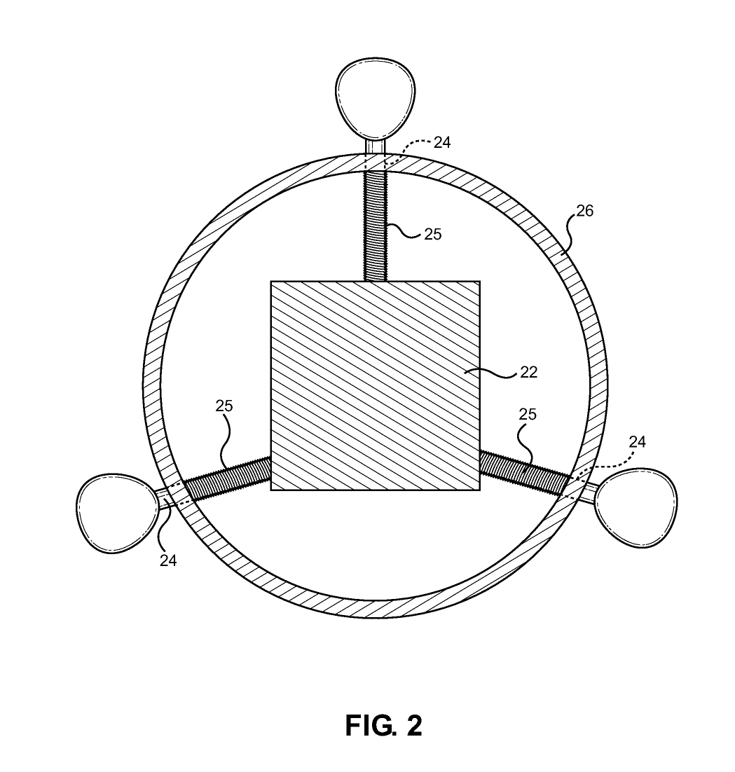

Referring now to FIG. 2, there is shown a cross-sectional view of the pole cover secured to a pole. The pole cover 26 is adapted to be mounted to a pole 22. The pole cover 26 is configured to secure to a pole 22 having any suitable cross sectional shape, such as a square or circle. The pole cover 26 comprises one or more attachment mechanisms. In the illustrated embodiment, an attachment mechanism comprises a plurality of mounting apertures 24 disposed along the length of the cover 26. A fastener such as a retainer screw 25 is inserted through each mounting aperture 24 and adapted to be inserted to be inserted within the pole 24 so as to secure the pole cover 26 thereto. When the parallel retainer screws are tightened against the pole 22, the cover 26 is secured to the pole 22 so that squirrels or birds may not cause the cover 26 to separate from the pole 22. In some embodiments, the retainer screw 25 includes a pointed end so as to penetrate poles constructed from wood. However, in other embodiments, the retainer screw 25 comprises a flat end for engaging with metal or plastic poles, or poles not easily penetrated.

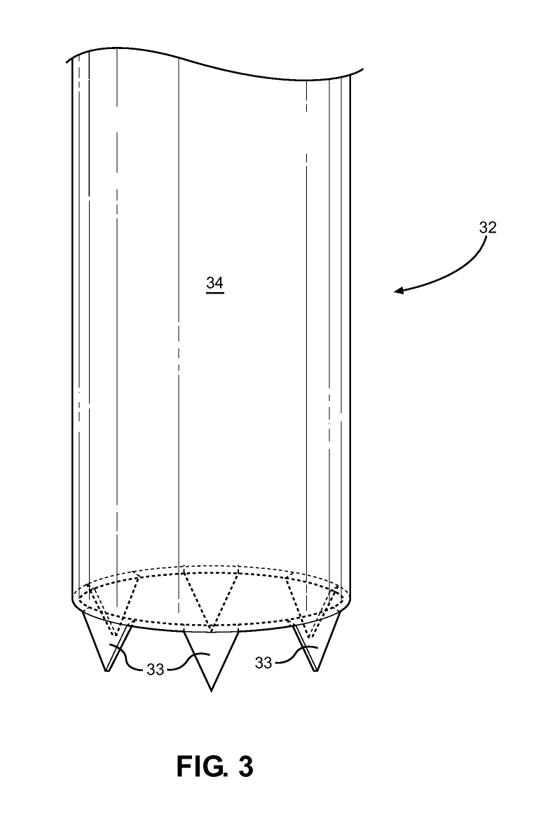

Referring now to FIG. 3, a perspective view of the bottom edge of the pole cover is shown. The pole has been omitted for visibility purposes. In the illustrated embodiment, the pole cover 32 comprises one or more spikes 33 disposed around the edge of the lower opening 15 of the cover 32. The spikes 33 are adapted to be inserted in the ground, thereby providing additional stabilization and support for the cover 32.

In order to use the present invention, a user first inserts a pole into the ground. The cover 32 is then slid over the pole and the food reservoir is mounted thereabove. It is preferable that the food reservoir be mounted flush with the cover 32 so as to prevent squirrels from utilizing a gap between the cover 32 and the food reservoir to reach the food therein. Alternatively, the cover 32 may exist in a non-cylindrical non-attached sheet, then wrapped around an existing bird feeder pole such that one vertical edge of the sheet is attached to the other, forming a cylindrical cover 32 around the pole. The edges of the cover 32 may be attached to one another via a typical attachment mechanism such as screws, rivets, or the like.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pole cover, comprising:
An axially elongated sheet having opposing vertical edges, said two opposing vertical edges attached to each other such that said unitary sheet is formed into a hollow cylinder, said hollow cylinder comprising an upper opening and a lower opening adapted to accept a pole therethrough.

2) The pole cover of claim 1, wherein said lower opening of said cover comprises one or more spikes disposed along the edge of said opening, wherein said spikes are oriented in the axial direction of said cover.

3) The pole cover of claim 1, wherein said hollow cylinder further comprises one or more mounting apertures disposed along the length of said hollow cylinder.

4) The pole cover of claim 1, wherein said cover comprises a non-stick coating on the outer surface of said cover.

5) The pole cover of claim 1, further comprising:
a pole having an upper end and a lower end;
and a feed reservoir secured to said upper end of said pole, wherein said feed reservoir is configured to hold bird feed therein.

6) The pole cover of claim 5, wherein said feed reservoir is flush with said upper opening of said hollow cylinder.

7) The pole cover of claim 3, wherein the one or more mounting apertures further comprise one or more fasteners inserted therethrough and adapted to secure the pole cover to a pole.
